(19) United States
(12) Patent Application Publication
(10) Pub. No.: US 2001/0051959 A1
(43) Pub. Date: Dec. 13, 2001

(54) Internet navigation tool and method and system for implementing such a tool

(76) Inventors: Bobby Penn, San Francisco, CA (US); Nicholas E. Brathwaite, Hayward, CA (US)

Correspondence Address: SAWYER LAW GROUP LLP, P.O. 51418, Palo Alto, CA, 94303, US

(21) Appl. No.: 09/754,759

(22) Filed: Jan. 4, 2001

Related U.S. Application Data
(60) Provisional application No. 60/182,078, filed on Feb. 11, 2000.

(51) Int. Cl. G06F 7/00

(52) U.S. Cl. 707/513

(57) ABSTRACT

A method and system for navigating the World Wide Web for information concerning a location is disclosed. The method and system comprises providing (102) a home page relating to the World Wide Web; and allowing (104) for the selection of a location within the World Wide Web. The method and system also includes allowing (106) for the navigation of the location to obtain information about an entity. The method and system in accordance with the present invention comprises a global information resource which provides news, information and access to products and services relating to and from various nations.

### CROSS-REFERENCE TO RELATED APPLICATION

This application is claiming under 35 USC 120 the benefit of provisional patent application Ser. No. 60,182,078 filed on Feb. 11, 2000.

### FIELD OF THE INVENTION

The present invention relates generally to an internet navigation tool and more particularly to a system and method for implementing such a tool.

### BACKGROUND OF THE INVENTION

In the past few years the Internet has become more appealing to the general population. The World Wide Web is offering individuals and businesses new ways to present and find information and as a result the number of people using the Internet is growing rapidly. For most users, however, accessing services through the Internet is still very cumbersome. The more cumbersome it is to access information and make payments the less likely it would be to attract mainstream consumers. There are sites which are utilized to access services on the Internet. For example, there are local sites, local portals and search engines. All of these sites have disadvantages which will be explained hereinafter.

Local Sites

A typical local site can be found on the Internet at http://www.orientation.com (“Orientation”). Orientation is a navigational website devoted to alternative regions of the world. Orientation, therefore, has targeted non-Western countries, excluding much of North America and all of Western Europe. In addition, Orientation's focus is on providing news and information with almost no e-commerce capability fused in a very cumbersome and non-intuitive design.

Level Portals

There are numerous localized portals such as http://www. centraleurope.com, http://www.euroseek.com., and http://www.afrika.com.

However, each of these sites concentrates on a specific region or county with a strong informational focus rather than e-commerce capacity. In addition, many of these sites are inconsistent in quality, ease of use and focus.

Search Engines

There are many different types of search engines available to Internet users, Yahoo, Alta Vista, etc. Partners and information can be researched and found through searches; however, this is currently extremely cumbersome. Because the information researched through search engines is organized primarily by content and not geographically, search engines do not easily facilitate consumer-based international electronic commerce.

Accordingly, what is needed is a system and method that overcomes the above-identified problems. The present invention addresses such a need.

### SUMMARY OF THE INVENTION

An Internet navigation tool is disclosed. The tool has the following features:

1. Nations are navigable from one page, utilizing drop down/pull down menus.

2. Each page combines the following features: (a) menu for weather in country's major cities; (b) time in country; (c) dial telephone/communication device directly from interface; (d) currency converter; (e) facts on country; (f) map and flag of country; (g) language translator; (h) news, information and entertainment (including radio and television); (i) business, government and political information; (j) stock quotes, ability to purchase and conduct online international stock trading; (k) chat groups, ability to post and respond to messages; (l) email service; and (m) online discussion groups, debates, through keyboard and voice.

3. Navigation of the various linked sites with an advertiser's banner, company logo and the ability to return to home, continent and country page.

The Internet navigation tool in a preferred embodiment uses standardized colors to signify different categories and countries. Preferably, information is arranged by category in columns (both horizontal and vertical) throughout. Finally, a standardization of design, color usage, and headers throughout the site/country is provided.

The Internet navigation tool comprises a global information resource, which provides news, information, travel, cultural background, entertainment, radio, television, and access to products and services relating to and from various nations with a country-specific focus by:

1. Providing all information “one click” away from the user.

2. When a link is selected, it takes you directly to the information provided (no need to further search).

3. Listing all relevant information on one page.

4. Providing most relevant data a user would ever need.

5. Providing targets and features for both consumers and businesses.

6. Organizing information in a logical and easy to read/comprehend fashion by use of sections and sub-sections.

This tool provides the ability to transact business and get most basic information about a country from one site.

An Internet navigation tool in accordance with the present invention is intended to make it easier to access news, information, products about and from any country by focusing on simplifying the user experience. The focus of Worldskip.com is on consumer-based international e-commerce.

### BRIEF DESCRIPTION OF THE DRAWINGS

FIG. 1 illustrates the user interface of a system in accordance with the present invention.

FIG. 2 is a home page in accordance with the present invention.

FIG. 2a is an example of the overlay and expanding tabs in accordance with the present invention.

FIGS. 3a-3c are an example of a country page, in this example, China.

### DETAILED DESCRIPTION

The present invention relates to an improvement in an internet navigation tool. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

The Internet navigation tool in accordance with the present invention reduces consumer frustration by providing an Internet site and services that make it easy and convenient for anyone to use the Internet to purchase goods and services in and from any country in the world.

The Internet navigation tool is not merely a search engine. The Internet navigation tool Internet site offers a blend of content and commerce focused on the international consumer. In addition to the general consumer, the Internet navigation tool is valuable to a user interested in doing business internationally. A simple and elegant, yet powerful Internet navigation tool is provided that offers the most common and sought after information, products and services.

By establishing a network of global, regional and country-specific partnerships, the Internet navigation tool provides a convenient and easy means for consumers or businesspersons to access and conduct business with providers of goods and services in and from any country. The Internet navigation tool establishes an Internet location where it is easy and convenient for buyers and sellers from anywhere in the world to meet.

In addition, the Internet navigation tool in accordance with the present invention offers simple and efficient access to online news, information, entertainment and sports as well as regional and country-specific, political and economic information which is organized by region and country.

The Internet navigation tool also provides (at the same Internet site) access to information regarding doing business in every country including easy and immediate access to information such as United States and Canadian government regulations on doing business in each, individual country. Import and export information as well as access to shipping and customs brokers will also be provided, making it easy to purchase and ship items to and from any country by accessing just one Internet site.

In addition to the general population of mainstream consumers using the Internet site to access goods, services, news and information from foreign countries, businesspersons will access the Internet navigation tool for the latest financial, political, economic and trade information regarding any country or region. By utilizing the Internet navigation tool, business professionals will find it easier to locate and order goods and services from countries other than the ones in which they live.

Major sections of the Internet navigation tool's Internet site targeted towards the international businessperson include: (1) international business; (2) import-export regulation; (3) government regulations; (4) banking and financial services; (5) industrial goods and supplies; (6) industry associations; and (7) business research.

A user is able to compare prices of goods and services throughout the world, purchase products and services or market their own goods and services, through a worldwide network by utilizing the Internet navigation tool.

For travel and entertainment consumers, the Internet navigation tool provides “quick facts” about every country, weather information about the period of interest (not just current weather) as well as hotel and other travel information. Easy access is provided to information and services that allow the consumer to book airline tickets, make hotel arrangements, reserve a rental car or order a taxi and make restaurant reservations.

Foreign-born individuals can utilize the Internet navigation tool to access news and information, purchase items or pay for services from their native lands for themselves or for friends and loved ones.

By utilizing the Internet navigation tool's Internet site, consumers will be able to order gifts and flowers directly from providers in any country from any other country in the world. A user can log on to the Internet navigation tool and purchase a gift for someone in another country and arrange to have it delivered.

For example, consumers will be able to log on and pre-pay for services such as telephone or electricity bills, mortgages, car payments, etc. not just for themselves but also for relatives or friends in other countries.

In addition to using the Internet navigation tool for international research and discussions, college students will also be able to access services that will facilitate signing up for classes, prepaying school fees and the purchasing of books. Eventually, the Internet navigation tool will facilitate signing up and prepaying for on or off campus residences in many locations all from one site.

In the early days of the Internet, Internet users were more technically competent and were able to use the current cumbersome navigation techniques to locate and research data. Today, however, many Internet users are less skilled technically. Internet users also come from a greater cross section of the population. According to a recent Adweek Study, Internet users now demand easier navigation and more concise information.

By providing an integration function for customers and businesses with emphasis on the consumer, and a regional focus rather than a content focus, the Internet navigation tool in accordance with the present invention adds value by making the electronic commerce experience a simple and pleasant one for international consumers.

Categories of User Services

The Internet navigation tool comprises four general interest sections offering a wide variety of information and e-commerce services to the user. Initially, all links and partnership advertisement will be organized within these general categories.

1. News and entertainment, which provides country-specific (or regional) news and information targeted at all market segments.

2. Business, economy and government, which provides general and e-commerce information for business professionals, immigrants and expatriates.

3. People, culture and travel, which provides data, information and e-commerce opportunities targeted towards the travel and tourism market segments; and

4. A “Marketplace” feature which provides e-commerce access to country-specific or regional providers of goods and services. Each of these features is described in detail hereinbelow.

News, Information and Radio Feature

This is a column on the Internet site containing the following sub categories, which link directly to specified sources with the primary focus of providing current news and information in the selected published or broadcasted language:

1. International news, which includes international newspapers covering the specific country, region, or delivering global news in one of the languages used in the region.

2. Regional news, which contains links to news and information sources with a primary focus on the region which the specific country is part of.

3. Regional business news, which contains links to business news sources covering the specific country's region.

4. Local national business, which contains links to national/local business resources.

5. National/local news, which contains links to country-specific news sources in the respective native/published language(s).

6. Sports, which contains sporting information including news, clubs, resources, leagues, teams, individuals, etc., pertaining to the specified country or region.

7. Magazines, which contains online magazines with either a regional or country specific focus.

8. National/local radio, which contains radio programs and live audio from the specified nation.

9. Regional radio, which contains radio programs and live audio from the specified region which the country is a part of.

10. Television, which contains television listings and video streaming of local and regional programming related to each specific country.

Business, Economy and Government Feature

This is a column on the Internet site containing the following sub categories, which link directly to specified sources with the primary focus of providing current news and information in the selected published or broadcasted language regarding:

1. Business, which includes business resources relating to establishing and conducting business in any specific country.

2. Regional business, which includes business resources relating to establishing and conducting business within a country's region.

3. Banking/finance, which includes financial information and resources for all aspects of financial transactions.

4. Economy, which includes national/local economic information.

5. Regional economy, which includes economic information relating to the region in which the country is located.

6. Embassy/consulate, which includes a listing of foreign embassies in country and worldwide locations.

7. Government, which includes country-specific government sites and statistics.

8. Foreign government information, which includes listings and resources published by governments other than that published by the government of the specified country.

Travel, Entertainment, People and Culture Feature

This is a column containing the following subcategories which link directly to specified sources with the primary focus of providing travel, cultural, ethnic and social information.

1. Travel, which includes travel information pertaining to places to visit, lodging, local transportation, documentation, health, points of interest, activities and events.

2. Transportation, which provides both local and regional transportation options.

3. Activities and events, which includes a listing of various activities, including social calendar, nightlife, sports, outdoors, festivals and public events.

4. People and culture, which includes a listing of information relating to and specific to the specified country's people and culture, including history, arts, literature, architecture.

5. The arts, comprising a listing of arts information, which can include music, folklore, dance and other traditional indigenous practices and events.

6. Education, which includes a listing of country and regional educational facilities and resources.

“Market Place” Feature

The “market place” feature is a display of in-country/region and relating to country/region partners who offer services and products including both consumable goods and durable goods as well as financial, legal, administrative, travel and technical services. Partners' sites can reside in and be maintained by either the Internet navigation tool or by the partner.

There is currently no Internet site devoted to a blend of international e-commerce, news and information with the breadth and simplicity of the Internet navigation tool in accordance with the present invention. In addition to being a source of information, products and services, the Internet navigation tool will eventually grow its interactive capabilities. Users will be able to customize their own pages, post to message boards, join virtual clubs, participate in chat groups and access e-mail and voice mail.

As part of an interactive offering, the Internet navigation tool will host a variety of discussion and debate forums targeting specific issues regarding political, economic and social policies in specific nations or regions. These discussions would include members of national governments and/or representatives from international organizations such as the United Nations, the Commonwealth Secretariat, the Organization of American States, etc.

The Internet navigation tool provides simple and intuitive Internet navigation with a consumer-based, global focus. The site is structured on a worldwide geographic platform with every nation available. Through the Internet navigation tool the world is at the computer user's fingertips. The Internet navigation tool provides an elegant alternative to tedious searches by providing information most users need or a place to begin a query.

The Internet navigation tool covers all nations on the globe with a strong focus on e-commerce capability as well as news, information and business resources in an easy to understand layout. The Internet navigation tool's breadth of information, usability, navigation and geographic region eclipses regional portals.

Premier Partnership

The premier partnership includes: (1) One or more graphic images of partner's log and/or advertising message displayed; and (2) Graphic is directly linked to partner's homepage.

To describe the features of the present invention, refer now to the following discussion in conjunction with the accompanying Figures.

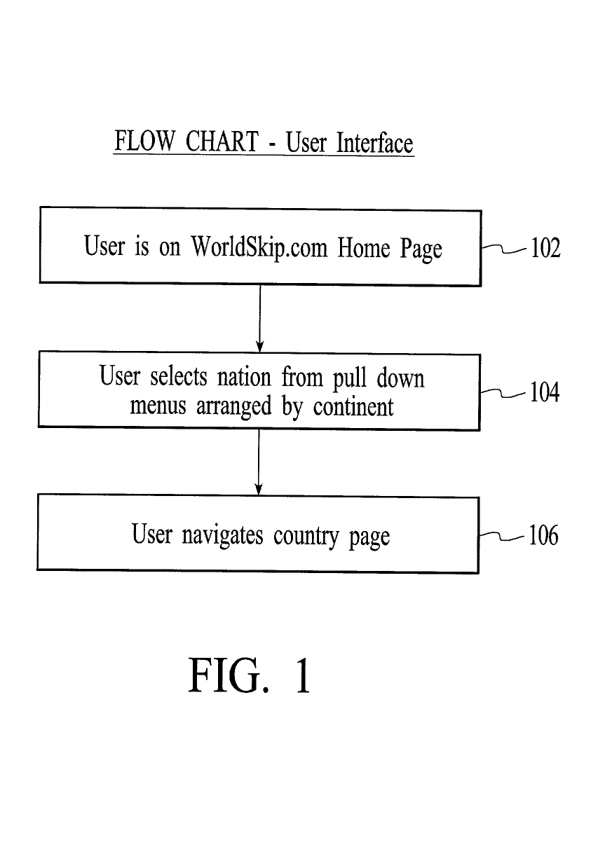

FIG. 1 illustrates the user interface of a system in accordance with the present invention. This interface is typically performed on a computer. The Internet navigation tool is implemented on a computer readable medium, such as a floppy disk, CD-ROM, DVD or a hard drive on the computer itself. The user is on an Internet navigation tool in accordance with the present invention's home page, via step 102. The user selects a specific nation from pull down menus arranged by continent, via step 104. The user then navigates through a specific country page, via step 106.

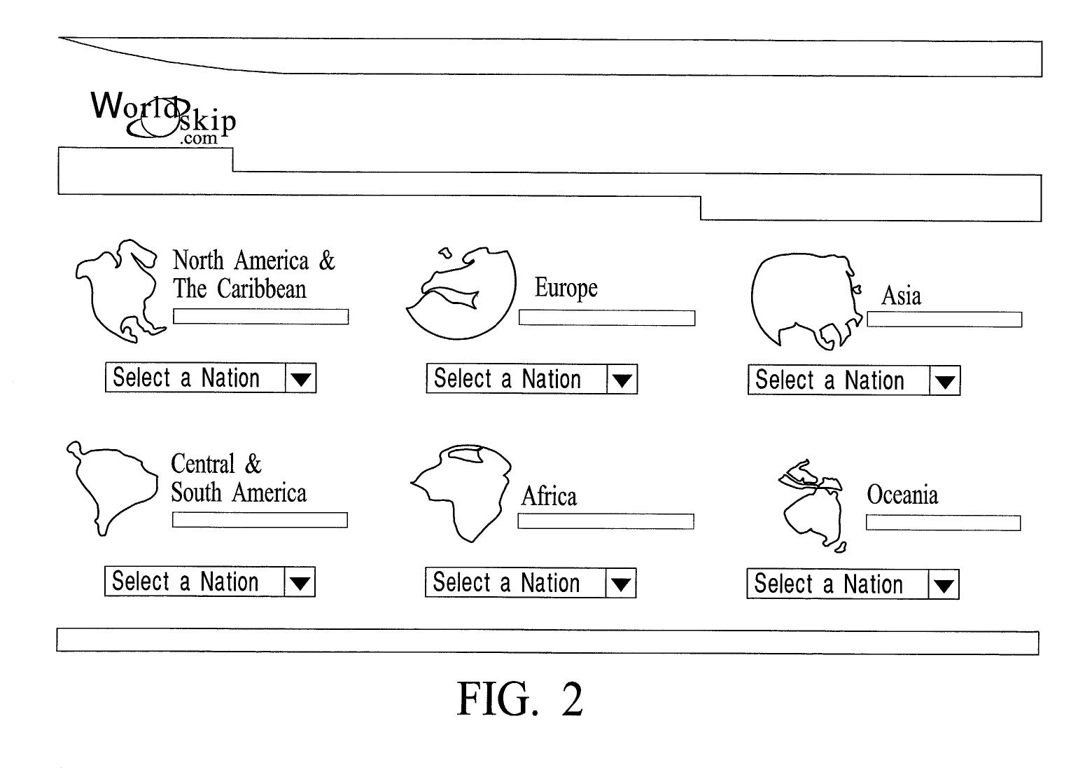

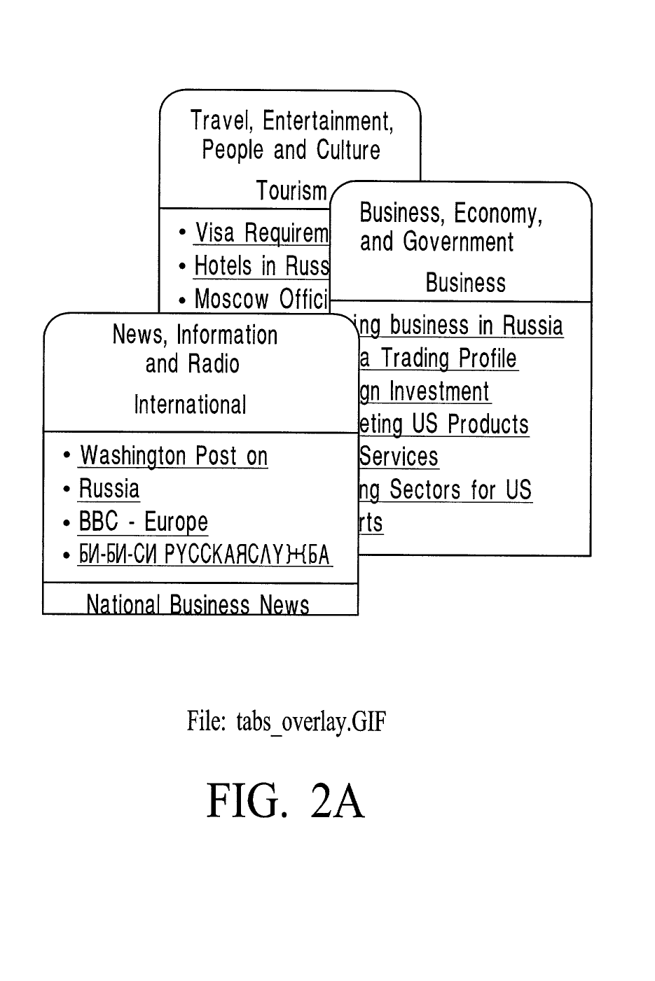

FIG. 2 is a home page in accordance with the present invention.

The home page of an Internet navigation tool in accordance with the present invention is comprised of a plurality of (in this case 6), Java-based pull down menus organized in a table format with North America, Europe and Asia arranged on the first row and South America, Africa and Oceania arranged on the second row. One of ordinary skill in the art recognizes that other embodiments of the present invention might feature different groups of continents and have a different number of rows, and their use would be within the spirit and scope of the present invention. Each menu corresponds to a continent, which lists every nation found within the borders of a specified region. The menu preferably is color-coded, matching the specified color for each continent/region pictured above its corresponding pull-down menu. Continents/regions and corresponding color codes are as follows:

1. North America and the Caribbean: (a) background color: dark orange-red, 993300, 153-51-0; (b) font color: pale week yellow, ffffcc, 255-255-204.

2. South and Central America: (a) background color: obscure dull yellow, 666600, 102-102-0; (b) font color: pale week yellow, ffffcc, 255-255-204.

3. Europe: (a) background color: dark azure blue, 003399, 0-510153; (b) font color: pale week yellow, ffffcc, 255-255-204.

4. Africa: (a) background color: dark spring green, 339900, 51-153-0; (b) font color: pale week yellow, ffffcc, 255-255-204.

5. Asia: (a) background color: dark faded red, 990000, 153-0-0; (b) font color: pale week yellow, ffffcc, 255-255-204.

6. Oceania: (a) background color: dark azuare cyan, 006699, 0-102-153; (b) font color: pale week yellow, ffffcc, 255-255-204.

Although these colors are utilized in a first embodiment of the present invention, other color and color combinations might be used and their use would be within the spirit and scope of the present invention.

Each link is linked directly to the corresponding country page and uses the naming structure of http://www.worldskip.com/countryname. Users are able to navigate directly to their specified country by typing in the full country name following the above-identified URL.

There are no go buttons. Each country selected in the menu navigates directly to the specified page once selected. There is no need to further navigate to the primary country page when selected from the home page. Each country is only one selection away. Accordingly, there is no need to offer search functions.

Expanding Tabs Feature

In the user interface of an Internet navigation tool in accordance with the present invention, tabs may be overlaid on each other, thus allowing the user to navigate back and forth in each section while still in the same browser and same site. See FIG. 2a.

Country Pages

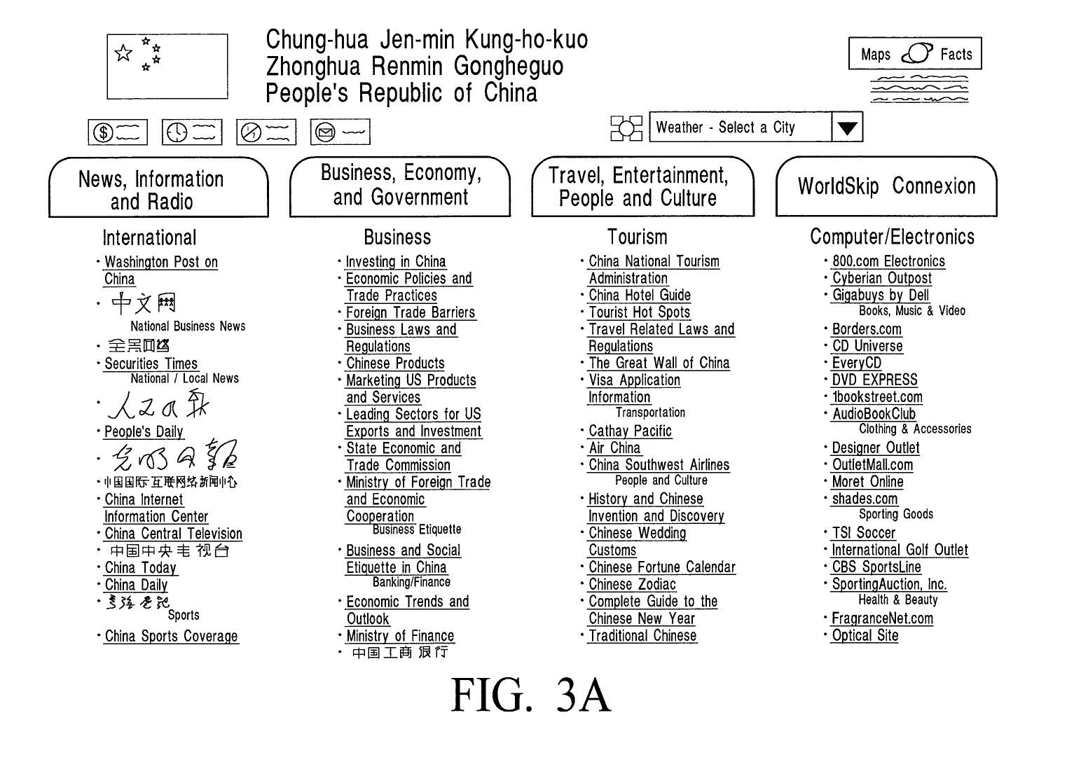

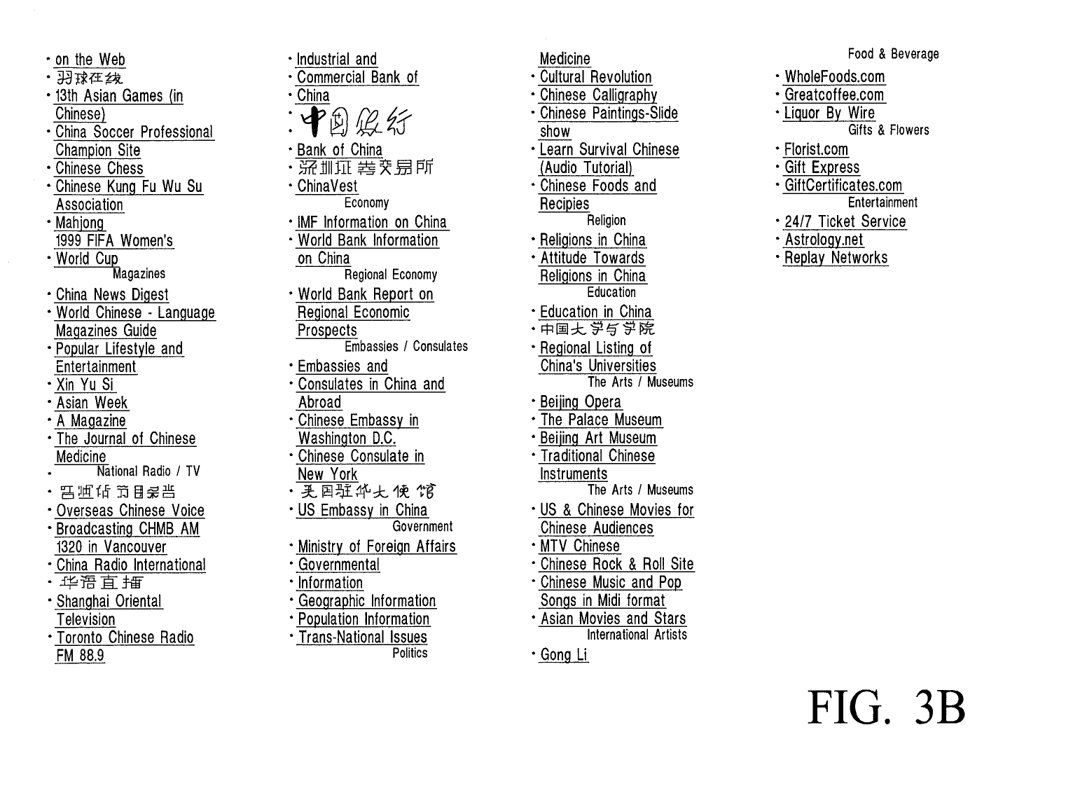

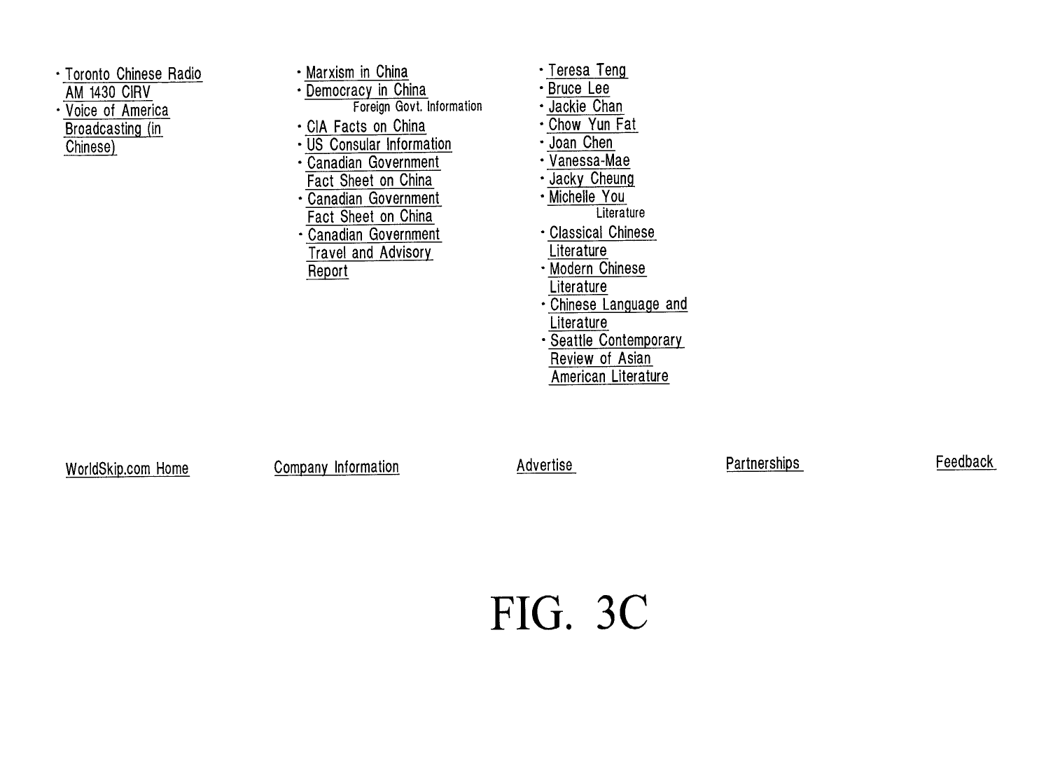

FIGS. 3a-3c are an example of a country page, in this example, China. As can be seen on this country page, the text is in both English and Chinese and can be accessed and navigated in both languages. Similarly, other country pages offer dual or multiple language access and navigation features.

Each country page is built on an HTML frame structure utilizing both the top navigation bar and the body of the page. There are three different files utilized in the file structure. The three files are named: (1) nav.shtml; (2) body.shmtl; and (3) index.html.

Navigation Bar/Nav.shtm

Specifications for the Navigation Bar/nav.shtm are as follows: margins: Top: 2, Left: 0, Right: 0, Bottom: 0; and background color: dark azure blue, 0-51-153,003399. The top frame contains the company logo with “HOME PAGE” scrolled below the logo and linked to the home page (http://www.worldskip.com).

In the center of the navigation file is an advertisement sized, for example, 486×60 pixels. To the right of the advertisement are:

1. A GIF graphic displaying the text “Return To”.

2. Below the “Return To” graphic is a link to the specified country (i.e., http://www.worldskip.com/countryname).

3. Below the link to the country is a server site which includes a menu listing all countries identified as part of an Internet navigation tool in accordance with the present invention. Each continent is color coded as indicated on the home page to the continent's specified color scheme.

Users can navigate to any country by simply selecting their country from the JAVA based menu. There is no “go” button. When the user is navigating through the site or linked pages, utilizing the navigation bar, which remains static, the user is able to return to the home page of a country page or any country part of an Internet navigation tool in accordance with the present invention.

Main Page/Body.shtml

The body.shtml contains the following sections: (a) country information and identifier; (b) country utility; (c) premier advertiser; (d) an Internet navigation tool in accordance with the present invention “Market Place”; (e) news, information and radio; (f) business, economy and government; (g) travel, entertainment, people and culture; and (h) an Internet navigation tool in accordance with the present invention “Connexion”.

Country Information and Identifier

The country information and identifier includes: (1) a GIF image of 100 pixels wide of the nation's flag; (2) country name in both English, and native language(s); and (3) a menu of facts and maps, which provide a link to (a) country information and facts, (b) map of country, and (c) map of region

Country Utility

The country utility includes: (1) GIF image “currency converter with icon of the US dollar sign” linking to a currency converter; (2) GIF image “time in country with a clock icon” providing link to time in country; (3) GIF image “language translator with an exclamation and question mark in a circle icon” linking to a language translator; (4) GIF image “feed back with a mail icon” allowing users to send comments to an Internet navigation tool in accordance with the present invention; and (5) Java based pull down menu, which lists major cities within the country providing a link to weather conditions of specified city. There is no “go” button. There is an icon, for example, the sun, identifying the menu as containing weather information.

Advanced Technologies

The site contains the following aspects which relate to advanced to technologies: (1) voice recognition capabilities; (2) eye positioning/color reaction capability for navigation; (3) interface using wireless technologies; (4) real time news, information, weather, financial, etc., updates on the site; (5) technologies for communications and data interchange; (6) real-time satellite and GPS capabilities; and (7) online interactive education.

Voice Recognition Feature

The voice recognition feature includes the ability to navigate the Internet site from an Internet-capable mobile telephone, and the ability to conduct a fully guided audio and video tour of the site.

E-commerce

The order-configurator is a real time interactive ordering system which accounts for varying standards and specifications throughout the world specific to individual nations for regulatory purposes, product standards, tariffs and customs.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the present invention.

What is claimed is:

1. A method for navigating the world wide web for information concerning a location, the method comprising the steps of:
(a) providing a home page relating to the World Wide Web;
(b) allowing for the selection of a location within the World Wide Web; and
(c) allowing for the navigation of the location to obtain information about the entity.

2. The method of claim 1 wherein the location comprises a nation.

3. The method of claim 1 wherein the home page comprises a plurality of nations arranged by content.

4. The method of claim 3 wherein each of the plurality of nations includes a country page.

5. The method of claim 4 wherein each of the nations are navigable utilizing drop-down/pull down menus.

6. The method of claim 5 wherein each country page includes any combination of the following features—menu for weather in country's major cities; time in country; dial telephone/communication device directly from interface; currency converter; facts on country; map and flag of country; language translator; news, information and entertainment (including radio and television); business, government and political information; stock quotes, ability to purchase and conduct online international stock trading; chat groups, ability to post and respond to messages; email service; and online discussion groups, debates, through keyboard and voice.

7. The method of claim 3 which includes the step of:
utilizing standardized colors to signify different categories and countries.

8. The method of claim 7 in which the information is arranged by category in columns.

9. A computer readable medium containing program instructions for navigating the world wide web for information concerning a location, the program instructions for:
(a) providing a home page relating to the World Wide Web;
(b) allowing for the selection of a location within the World Wide Web; and
(c) allowing for the navigation of the location to obtain information about the entity.

10. The computer readable medium of claim 9 wherein the location comprises a nation.

11. The computer readable medium of claim 9 wherein the home page comprises a plurality of nations arranged by content.

12. The computer readable medium of claim 11 wherein each of the plurality of nations includes a country page.

13. The computer readable medium of claim 12 wherein each of the nations are navigable utilizing drop-down/pull down menus.

14. The computer readable medium of claim 13 wherein each country page includes any combination of the following features: menu for weather in country's major cities; time in country; dial telephone/communication device directly from interface; currency converter; facts on country; map and flag of country; language translator; news, information and entertainment (including radio and television); business, government and political information; stock quotes, ability to purchase and conduct online international stock trading; chat groups, ability to post and respond to messages; email service; and online discussion groups, debates, through keyboard and voice.

15. The computer readable medium of claim 11 which includes program instructions for:
utilizing standardized colors to signify different categories and countries.

16. The computer readable medium of claim 15 in which the information is arranged by category in columns.
